(19) United States
(12) Patent Application Publication
(10) Pub. No.: US 2008/0282901 A1
(43) Pub. Date: Nov. 20, 2008

(54) Laser Cooking Apparatus

(76) Inventor: Boris Muchnik, Henderson, NV (US)

Correspondence Address: GREENBERG & LIEBERMAN, LLC, 2141 WISCONSIN AVE, N.W., SUITE C-2, WASHINGTON, DC, 20007, US

(21) Appl. No.: 11/571,024

(22) PCT Filed: Mar. 23, 2006
(86) PCT No.: PCT/US2006/010670

§ 371 Date: Dec. 20, 2006

Related U.S. Application Data
(60) Provisional application No. 60/594,257, filed on Mar. 23, 2005.

(51) Int. Cl. A47J 36/00

(52) U.S. Cl. 99/325

(57) ABSTRACT

An apparatus and method for cooking food directly with a CO₂ laser (10). A CO₂ laser (10), which is known to be much hotter the other types of laser is directed at a beam splitter (30) which splits the laser beam in half and then mirrors are used to focus said beam to either side of the food which one wants to cook. The beams are much hotter then most types of lasers and as such most foods will be cooked in less then a second.

This application claims priority to provisional application 60/594,257 filed on Mar. 23, 2005.

### FIELD OF THE INVENTION

The present invention relates to the use of lasers to cook food. More particularly, the present invention relates to the use of CO2 lasers to prepare food.

### BACKGROUND OF THE INVENTION

Lasers have been used in conjunction with cooking in the past.

Japanese Patent Publication No. JP63003131A2 by Terakubo Kiyoshi for a Laser Cooking Device published on Jan. 8, 1988, discusses how to eliminate the generation of poisonous gas perfectly and improve thermal efficiency, by utilizing laser beams as a cooking means, where a laser oscillator is used to heat the bottom of a cooker. Unlike the present invention, Kiyoshi's device does not heat the food directly with a laser. Kiyoshi's device employs a laser oscillator to, as aforementioned heat the bottom of a cooker.

U.S. Pat. No. 5,881,634 issued to Robert K. Newton on Mar. 16, 1999, shows a two-sided cooking system with laser markings. Newton's device is a two-sided cooking system utilizing an upper platen and a lower platen, where the periphery of the upper platen is marked on the lower platen by a laser-etched marking. The laser-etched marking provides a wear resistant marking which withstands the scraping and scrubbing operations associated with using and cleaning Newton's device. Unlike the present invention, Newton's device does not use a CO2 laser to cook food, but rather, has the remnants of a laser as wear resistant marking.

Japanese Patent Publication No. JP2002147762A2 by Asano Hideki for a Food Cooking Apparatus published on May 22, 2002, discusses a microwave oven that has a laser irradiation unit which irradiates a laser beam having a specific wavelength onto foodstuffs accommodated in cooking chamber. Hideki's device has an abstract that reads as follows:
The internal part of an outer wall 1 is divided into a cooking chamber 2, a machine room 3, and a control chamber 4. From the ceiling of the cooking chamber 2, a food 15 in the cooking chamber 2 is irradiated with laser beam emitted from a laser beam source 5 through an optical fiber 6. The machine room 3 is provided with a magnetron 7, a wave guide 8, and a fan 10 to discharge heat generated from the internal part of the machine room 3. Further, a heater 9 for an oven is stretched around the ceiling of the cooking chamber 2. Two kinds of semiconductor lasers having different wavelengths of 0.8 μm and 1.5 μm are coupled to the respective optical fibers. Further, the cooking chamber 12 is provided at its back with a fan 12 to discharge gas generated in the cooking chamber to the outside of the heating chamber, and at the side of the cooking chamber 2 with an intake part 11 to guide air to the cooking chamber 2.
   Hideki's device is overly complicated and expensive, and also requires a wave form for control.

### SUMMARY OF THE INVENTION

The present invention introduces a simplified method and apparatus for using a laser to cook food. A co2 laser, which is know to be much hotter then other types of laser is directed at a beam splitter which splits the laser beam in half and then mirrors are used to focus said beams to either side of the food which one wants to cook. The beams are much hotter then most types of lasers and as such most foods will be cooked in less then a second. Further, by cooking food at such high speeds the juices will be sealed in. Additionally, this gives new meaning to “fast food” where in it is truly prepared FAST and it is going to be far better for a person as there will be no time for the oils to burn thereby preventing any trans fats from being created in the cooking process.

### BRIEF DESCRIPTION OF THE DRAWING

FIG. 1 shows an above view of the laser and beams with beam splitter and mirrors cooking a food item of the present invention.

### DETAILED DESCRIPTION OF THE PREFERRED EMBODIMENTS

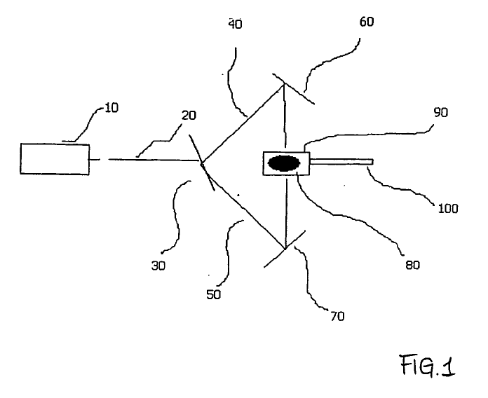

FIG. 1 shows a co2 laser (10), emitting a laser beam (20), which is directed in to a laser beam splitter (30) which splits said beam (20) into two laser parts (40 & 50). The beam splitter (30) is a known device which uses the Brewster angle to split the beam.

In the preferred embodiment, the first laser part (40) is directed to first mirror (60), while the second laser part (50) is directed to second mirror (70). Both first mirror (60) and second mirror (70) are angled so as to direct first laser part (40) and second laser part (50) towards each other and onto a piece of food (80). The piece of food (80) sits on or in a standard metal tray (90), and the tray (90) is held in the path of the first laser part (40) and second laser part (50) by a conventional mechanical arm (100). The ability to move a conventional mechanical arm (100) is well known and alternate methods of holding, delivering or manipulating the piece of food (80) are contemplated. For example, other well known and alternate methods of holding the piece of food (80) are pushing a conventional spike through the piece of food (80); or holding the piece of food (80) in a conventional glass enclosure that will not stop first laser part (40) and second laser part (50); or allowing the food (80) to fall in a chute to the cooking place and then be allowed to fall further to the customer.

A co2 laser (10) is the preferred method as: (a) it has a beam which is divergent and (b) it has a wave length of 10.6 microns which is 20 times the wave length of visible light and therefore has a depth of penetration into a substance which is much greater then other types of lasers (10) which is easily calculated and will always be the same. The depth and speed of penetration will of course also be in direct relation to the power of the laser (10) and the opacity of the substance, in this case the food (80).

For purposes of this description, a 50 watt co2 laser (10) is employed, and more specifically the Synrad Model 48-5W, a 50 W sealed tube CO2 laser. This is just one example of a commercially available co2 laser (10) and it has been chosen as it is sealed, quite small and has redundant tubes. Redundant tubes allow the present invention to maintain functionality even if one of the tubes fails, although the cooking time would double should one tube fail. Of course many of lasers (10) and models would work as well and in the commercial version of this invention it is possible a different laser (10) would be used in accordance with cost, size, availability and power. A change in the laser (10) would change the cook times placed in the database and possibly the optional lense(s) (not shown) that may be placed on either side of the food or depending on the size of the mirrors (70) after the splitter (30). The purpose of the lenses (not shown) would be to expand or contract the first laser part (40) and second laser part (50) to cover the food (80) completely.

When using a Synrad Model 48-5W as the co2 laser (10), less then 1/16th of cooking time is necessary to cook a 1 inch hamburger all the way through. As heat penetration always with a co2 laser (10) will move from the outside surface of a hamburger toward the hamburger's center, a second shorter pulse of the co2 laser (10) could be used to char the burger on the outside, so that the appearance of grill cooking is achieved. The use of multiple pulses of co2 laser (10) timed differently will allow a customer to choose exactly how cooked or uncooked a piece of food (80) would be and appear.

The timing, for laser beam (20) interacting with different pieces, of food (80), is contemplated to be placed in a conventional a computer database and all cooking can be automated based upon the likes and/or dislikes of the individual user. That is, the timing would be as conventional as the timing typically found in a microwave oven wherein preprogrammed settings are employed for controlling the timing of the conventional microwave oven magnetron interacting with different pieces of food (80).

It is further contemplated that the present invention can facilitate quick food (80) preparation in a commercial kitchen. For example, food (80) could be taken out of a conventional freezer, placed in a conventional mechanical hopper automatically via conventional means, and funneled into the path of the first laser part (40) and second laser part (50) to be cooked. Such quick food (80) preparation would occur rather automatically and thus, less employees would be necessary to run a kitchen.

It is further contemplated that the present invention, in another embodiment, could be completely automated in a vending machine format with food (80) that is refrigerated using any number of conventional means allowing a customer to order food (80) cooked precisely as desired. The food (80) would be cooked in mere seconds via the present invention so that the customer would receive food (80) cooked within seconds of ordering via the vending machine.

The present invention is a method of cooking that absolutely kills all germs because of the tremendous intensity of heat, allowing the present invention to be a much safer method of cooking food (80) then all known previous methods.

Another embodiment of the present invention has food (80) rotating and the laser (10) is aimed directly at the food (80). The advantage to this configuration is that a reflected laser beam (20) has much less power then a direct beam, so this embodiment would allow the laser beam (20) to cook the food more directly, and power would be saved because the laser beam (20) would not be powered for a shorter duration than in an embodiment a reflected laser beam (20). The disadvantage to this embodiment is that rotating food (80) requires additional moving parts, and this means that there is a greater chance for the present invention to fail in accomplishing its goals.

Another alternative embodiment involves the use of multiple lasers (10) to cook food (80). While multiple lasers (10) would obviate the need for rotating food (80) because the food (80) would be cooked via multiple lasers (10), multiple lasers (10) makes the present invention substantially more costly because more than one laser (10) is employed. The preferred embodiment of the present invention is believed to be the most efficient.

I claim:

1. An apparatus for cooking food, comprising:
a CO₂ laser;
a laser beam, emitted from said laser;
a laser beam splitter, positioned to split said laser beam into a first laser part and a second laser part;
a first mirror, positioned to direct said first laser part at a piece of food; and
a second mirror, positioned to direct said second laser part at the piece of food.

2. The apparatus of claim 1, further comprising a computer system in communication with said CO2 laser.

3. The apparatus of claim 2, wherein said computer system has software having a database of foods and laser penetration times associated with said database of foods.

4. The apparatus of claim 3, wherein said software allows a user to choose how a particular type of food is cooked and automatically, manipulating the laser accordingly.

5. The apparatus of claim 1, further comprising a mechanical arm that moves the food in and out of the path of said first laser part and said second laser part.

6. The apparatus of claim 1, further comprising a refrigeration system in communication with said CO2 laser, said refrigeration system storing the food until the food hit by said laser beam.

7. An apparatus for cooking food, comprising:
a CO₂ laser;
a laser beam, emitted from said laser; and
a method for controlling said laser beam for cooking the food.

8. The apparatus of claim 7, wherein said food is rotated.

9. An apparatus for cooking food, comprising:
multiple CO₂ lasers; and
laser beams, emitted from said multiple CO₂ lasers;
wherein said laser beams are directed at the food.
